(19) United States
(12) Patent Application Publication
(10) Pub. No.: US 2015/0199370 A1
(43) Pub. Date: Jul. 16, 2015

(54) INFORMATION MANAGEMENT METHOD, CLIENT AND MOBILE TERMINAL

(71) Applicant: Tencent Technology (Shenzhen) Company Limited, Shenzhen, Guangdong (CN)

(72) Inventors: Dongmin Zheng, Guangdong (CN); Yongzhou Lv, Guangdong (CN)

(21) Appl. No.: 14/419,695

(22) PCT Filed: Aug. 12, 2013
(86) PCT No.: PCT/CN2013/081302

§ 371 Date: Feb. 5, 2015

(30) Foreign Application Priority Data
Aug. 16, 2012 (CN) 201210292171.7

(51) Int. Cl. G06F 17/30

(52) U.S. Cl. CPC G06F 17/3089; G06F 17/30575

(57) ABSTRACT

The present disclosure relates to the technical field of computers, and disclosed are an information management method, a client, and a mobile terminal. The method includes: receiving a write operation sent by a user for a currently displayed web application; determining a current state of communication with a web server; when communication with the web server cannot be performed currently, prompting the user on whether to save written data corresponding to the write operation; when the user chooses to save the written data, saving the written data locally, so that during communication with the web server next time, the written data is synchronized to the web server. The dependency of the write operation for the web application on the network is decreased, so that the user can share information timely.

### CROSS REFERENCE TO RELATED APPLICATIONS

This present application claims the benefit of priority to China Patent Application No. 201210292171.7 filed in the Chinese Patent Office on Aug. 16, 2012 and entitled “INFORMATION MANAGEMENT METHOD AND CLIENT”, the content of which is incorporated herein by reference in its entirety.

### FIELD

The present invention relates to the technical field of computers, more particularly, to an information management method, a client and a mobile terminal.

### BACKGROUND

Web application is an application based on web, its function is to issue a set of complex content and application functions to a great mass of end users. The end users can connect to networks through a web browser, obtain appropriate web applications from a web server, run and display obtained web applications. Thus, the end users can browse issued content on the web applications, and can use the application functions provided by the web application, to realize the purpose of information sharing and leisure entertainment, etc.

In the existing technology, a common web application includes a SNS (Social Networking Services) application, the SNS application is a community sharing type application which can provide internet application service to establish social network for the great mass of end users, to satisfy user demands for sharing the events and moods here and now. Specifically, if the browser is online, i.e., the browser is on a state of communication with the SNS server, the user can issue information such as contents on SHUOSHUO and logs in real-time through write operations provided by the SNS application which is currently displayed on the browser.

It can be knew from the above descriptions, the existing web application needs to connect and access to the network through the browser. However, if the browser is offline, namely, the browser and the web server fails to communicate with each other, the user can not use the write operation provided by the web application, so that the user can not share information in a timely manner.

### SUMMARY OF THE INVENTION

In order to solve the problems of the existing technology, the present disclosure provides an information management method, a client and a mobile terminal. Technical solutions are described in detail as follows.

One embodiment of the present invention provides an information management method. The information management method includes:

receiving a write operation sent by a user for a currently displayed web application;

determining a current state of communication with a web server;

when communication with the web server cannot be performed currently, prompts the user on whether to save written data corresponding to the write operation; and

when the user chooses to save the written data, saving the written data locally, so that during communication with the web server next time, the written data is synchronized to the web server.

Another embodiment of the present invention provides a client. The client includes: a first receiving module, a determining module, a first prompting module and a saving module;

the first receiving module, configured to receive a write operation sent by a user for a currently displayed web application;

the determining module, configured to determine a current state of communication with a web server;

the first prompting module, configured to prompt the user on whether to save written data corresponding to the write operation when communication with the web server cannot be performed currently;

the saving module, configured to save the written data locally when the user chooses to save the written data, so that during communication with the web server next time, the written data is synchronized to the web server.

Yet another embodiment of the present disclosure provides a mobile terminal. The mobile terminal includes a storage, one or more than one processors and one or more than one program instructions stored in the storage for execution by the one or more than one processors, the one or more than one program instructions comprising instructions: a first receiving instruction, which is configured to receive a write operation sent by a user for a currently displayed web application;

a determining instruction, which is configured to determine a current state of communication with a web server;

a first prompting instruction, which is configured to prompt the user on whether to save written data corresponding to the write operation when communication with the web server cannot be performed currently;

a saving instruction, which is configured to save the written data locally when the user chooses to save the written data, so that during communication with the web server next time, the written data is synchronized to the web server.

In the embodiments of the present invention: when communication with the web server cannot be performed currently, may prompts the user on whether to save the written data corresponding to the write operation, and when the user chooses to save the written data, saves the written data locally, so that during communication with the web server next time, the written data is synchronized to the web server, the dependency of the write operation for the web application on the network is decreased, so that the user can share information timely.

### BRIEF DESCRIPTION OF THE DRAWINGS

In order to make the technical schemes clearer, now simply describes the drawings related to the embodiments, obviously, the drawings described herein are only some embodiments of the present invention, based on the embodiments of the present invention, all of other drawings can be obtained by the person skilled in the art who have not do any creative labor.

FIG. 1 is a flowchart of an information management method according to a first embodiment of the present disclosure;

FIG. 2 is a flowchart of an information management method according to a second embodiment of the present disclosure;

FIG. 3a is a flowchart of an information management method according to the second embodiment of the present disclosure;

FIG. 3b is a schematic diagram of a page for writing log thereon provided by the present disclosure;

FIG. 4 is a structure diagram of a client according to a third embodiment of the present disclosure;

FIG. 5 is a structure diagram of a client according to the third embodiment of the present disclosure;

FIG. 6 is a structure diagram of a client according to the third embodiment of the present disclosure;

FIG. 7 is a structure diagram of a client according to the third embodiment of the present disclosure;

FIG. 8 is a structure diagram of a client according to the third embodiment of the present disclosure; and

FIG. 9 is a structure diagram of a mobile terminal related to the embodiments of the present disclosure.

### DETAILED DESCRIPTION OF ILLUSTRATED EMBODIMENTS

Further descriptions of the embodiments of the present disclosure will be illustrated, which combined with drawings, in order to make the technical schemes more clearly.

### A First Embodiment

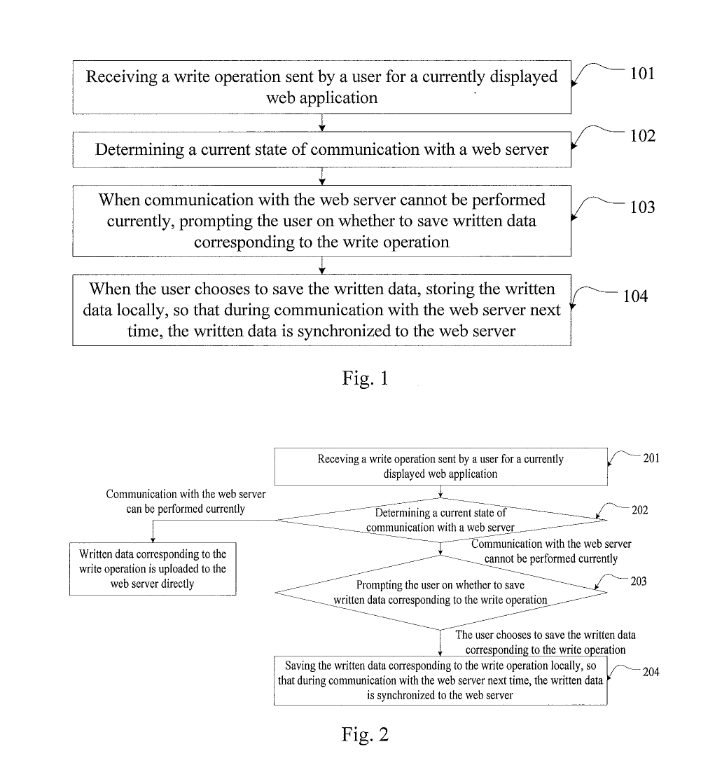

Referring to FIG. 1, the present disclosure provides an information management method according to a first embodiment, the information management method at least includes steps as follows.

Step 101: receiving a write operation sent by a user for a currently displayed web application;

Step 102: determining a current state of communication with a web server;

Step 103: when communication with the web server cannot be performed currently, prompting the user on whether to save written data corresponding to the write operation;

Step 104: when the user chooses to save the written data, storing the written data locally, so that during communication with the web server next time, the written data is synchronized to the web server.

In the embodiment of the present disclosure: when communication with the web server cannot be performed currently, the user can be prompted on whether to save the written data corresponding to the write operation, and when the user chooses to save the written data, the written data is stored locally, so that during communication with the web server next time, the written data is synchronized to the web server. Thus, the dependency of the write operation for the web application on the network is decreased, so that the user can share information timely.

### A Second Embodiment

In the embodiment of the present disclosure, the user may access to a web application through a browser by using two ways as follows.

In a first way, when the browser is in an online state, namely, when the browser is on a state of communication with a web server, when the browser receives a request for accessing to the web application sent by the user, then the browser obtains the web application from the web server which is communicated with the browser, and displays the web application.

In a second way, when the browser is in an offline state, namely, when the browser fail to establish communication with the web server, when the browser receives a request for accessing to the web application sent by the user, the browser runs locally saved offline resource files corresponding to the web application, and displays the web application; Wherein, the offline state (i.e., when the browser fail to establish communication with the web server) may include: the browser disconnecting with the network currently, the web server being busy or abnormal, or unstable network environment, or the web server unable to response to the request from the browser.

Then, in order to ensure that the browser can still provide the application for the user when in the offline state, the present disclosure provides a method for establishing offline web application, establishing offline web application begins from the online web application. When the browser is connected with the network and first accesses to the web server, the web server will notify the browser to download required offline resource files that ensure the web application can be accessed when the browser is in the offline state, and after the browser receives a notification, the browser downloads the offline resource files corresponding to the web application from the web server. The offline resource files may be HTML (Hypertext Markup Language) files, Javascript files, images or video files etc., and the offline resource files are saved locally. Thus, when the browser is in the offline state, the browser may open the web application through running the offline resource files saved locally corresponding to the web application, so that the user can still access to the web application without a network connection environment.

Through establishing the offline web application above-mentioned, so that the user may access to the web application without regard to the network state (whether the browser is connected to the web server or not), and can access to the offline web application through the browser whenever and wherever possible.

When the user accesses to the web application through the browser based on the above-mentioned method, the user may use the application functions provided by the web application. In order to ensure that when the browser cannot communicate with the web server, the user can still access to the web application to perform a write operation, the present disclosure provides an information management method. The information management method can be performed by a mobile phone, a tablet PC (personal computer), a computer, or other client devices, or can also be performed by a browser client installed on the client equipments. Referring to FIG. 2, the information management method may include the following steps in detail.

Step 201: receiving a write operation sent by a user for a currently displayed web application.

Step 202: determining a current state of communication with a web server.

When communication with the web server cannot be performed currently, step 203 is performed.

When communication with the web server can be performed currently, written data corresponding to the write operation is uploaded to the web server directly.

In the embodiment of the present disclosure, the ways for determining a current state of communication with a web server can be described as follows.

The first way: detecting a navigator.onLine interface; when the value of the navigator.onLine interface is detected to be true, then the browser may communicate with the web server currently, and when the value of the navigator.onLine interface is detected to be false, and then the browser may not communicate with the web server currently.

The second way: monitoring online events or offline events; when the online events are monitored, then the browser may communicate with the web server currently, and when the offline events are monitored, and then the browser may not communicate with the web server currently.

Step 203: prompting the user on whether to save written data corresponding to the write operation.

When the user chooses to save the written data corresponding to the write operation, then step 204 is performed.

When the user chooses not to save the written data corresponding to the write operation, the process ends.

In the present embodiment, the user is prompted on whether to save the written data corresponding to the write operation through a pop-up window, and the user is prompted on the current state of communication with the web server, so that the user may obtain the current state of network timely.

Step 204: saving the written data corresponding to the write operation locally, so that during communication with the web server next time, the written data is synchronized to the web server.

In the present embodiment, the way of saving the written data corresponding to the write operation may include:

saving the written data using a LocalStorage mechanism, or saving the written data using a WebDatabase mechanism, or saving the written data using a SessionStorage mechanism.

Wherein, the LocalStorage mechanism and the SessionStorage mechanism adopt a Key/Value saving mechanism, and transform the written data into a string in JSON (Javascript Object Notation) form, which can be realized by a performance function JSON.stringify(json) of the browser; after that, the written data whose format is transformed is locally saved by means of a local storage function localStorage.setItem(key,vlue) of the browser; but the difference between the LocalStorage mechanism and the SessionStorage mechanism is: the LocalStorage mechanism can store the written data whose format is transformed into a local cache, the SessionStorage mechanism can store the written data whose format is transformed in a current browser session. The WebDatabase mechanism can locally store the written data in a way of relational database.

In the embodiment of the present disclosure, during communication with the web server next time, the user is prompted on whether to issue the written data that is locally saved. In particular, the user is prompted on whether to issue the written data through a pop-up window, and is prompted on the current state of communication with the web server, so that the user may obtain the current state of network timely. In addition, when the user chooses to issue the written data that is locally stored, the written data is synchronized to the web server.

In the embodiment of the present disclosure, when communication with the web server cannot be performed currently, the user may be prompted on whether to save the written data corresponding to the write operation, and when the user chooses to save the written data, then the written data can be saved locally, so that the written data is synchronized to the web server during communication with the web server next time. Thus, the dependency of the write operation for the web application on the network is decreased, and the user can share information timely.

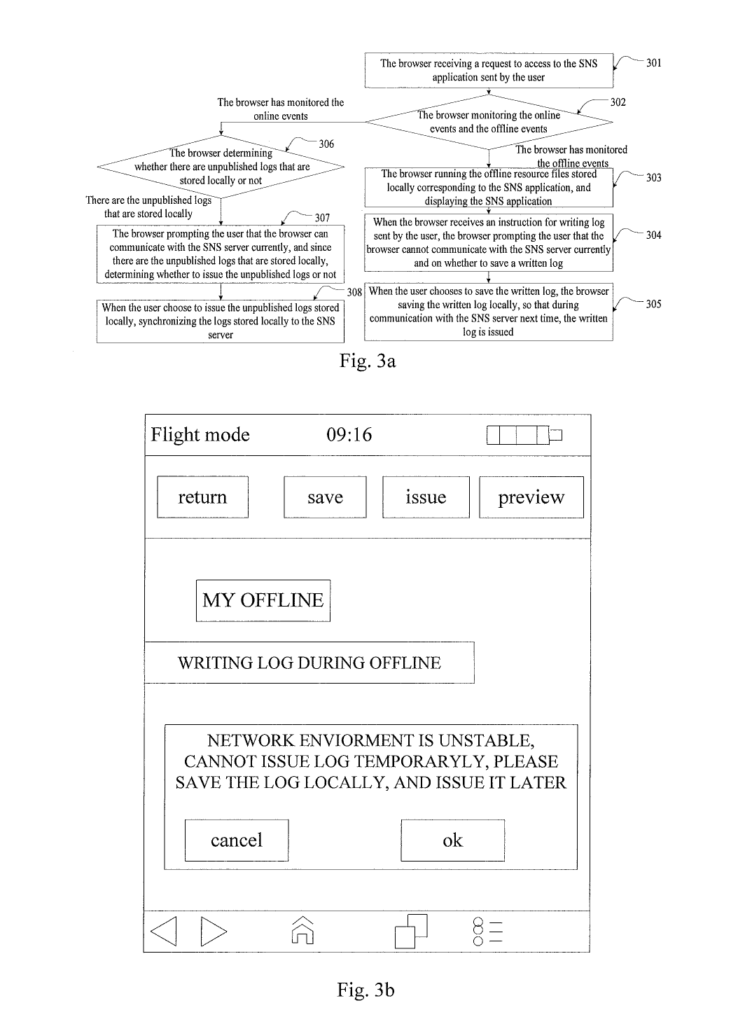

Taking the process of writing log in a SNS application of the web application as an example, the technical solutions above-mentioned will be described in detail. The browser locally caches the offline resource files, so that the SNS application can be accessed offline. Referring to FIG. 3a, it provides a flowchart of an information management method, which still allows the user to access to the SNS application to perform the write operation through the browser even when the browser is in the offline state. The information management includes the following steps particularly.

Step 301: the browser receiving a request to access to the SNS application sent by the user.

Step 302: the browser monitoring the online events and the offline events;

when the browser has monitored the offline events, i.e., the browser cannot communicate with a SNS server currently, then step 303 is performed by the browser;

when the browser has monitored the online events, i.e., the browser is communicating with the SNS server currently, then step 306 is performed the browser.

Step 303: the browser running the offline resource files stored locally corresponding to the SNS application, and displaying the SNS application, so that the user can still access the SNS application even when the browser cannot communicate with the SNS server, and can write log based on a function of “Writing Log” provided by the SNS application.

Step 304: when the browser receives an instruction for writing log sent by the user, the browser prompting the user that the browser cannot communicate with the SNS server currently and on whether to save a written log;

FIG. 3b is a schematic diagram of a page for writing log thereon provided by the present disclosure. Referring to FIG. 3b, when the browser has received the instruction for writing log sent by the user, namely, when the browser has checked a selected operation for “ISSUE” option or “WRITING LOG DURING OFFLINE” option, the browser pops up a prompt dialog box of “NETWORK ENVIRONMENT IS UNSTABLE, CANNOT ISSUE LOG TEMPORARILY, PLEASE SAVE THE LOG LOCALLY, AND ISSUE IT LATER”, to prompts the user that the browser cannot communicate with the SNS server currently and on whether to save the written log.

Step 305: when the user chooses to save the written log, the browser saving the written log locally, so that during communication with the SNS server next time, the written log is issued, and then the process ends, and the way of storing the written data is depicted in detail in the step 204, which will not be repeated here again;

By perform the above operations, the user can still access the SNS application and perform the write operation, even when the browser cannot communicate with the web server. The dependency of the write operation for the SNS application on the network is decrease, so that the user can record events and mood through the SNS application whenever and wherever possible.

Step 306: the browser determining whether there are unpublished logs that are stored locally or not;

if there are the unpublished logs that are stored locally, the browser performs a step 307;

if there are not the unpublished logs that are stored locally, the process ends.

Step 307: the browser prompting the user that the browser can communicate with the SNS server currently, and since there are the unpublished logs that are stored locally, determining whether to issue the unpublished logs or not;

referring to FIG. 3b, the unpublished logs may be stored in a folder of “MY OFFLINE” which can store a plurality of logs, the browser can selectively issue any log in the folder chose by the user.

Step 308: when the user choose to issue the unpublished logs stored locally, synchronizing the logs stored locally to the SNS server.

Through the steps 306 to 308, during communication with the SNS sever again, the browser can timely remind the user that there are logs locally stored by the browser, which are written by the user in the state that the browser is offline, so that the logs written in the offline state can be synchronized to the SNS server to be issued timely.

### A Third Embodiment

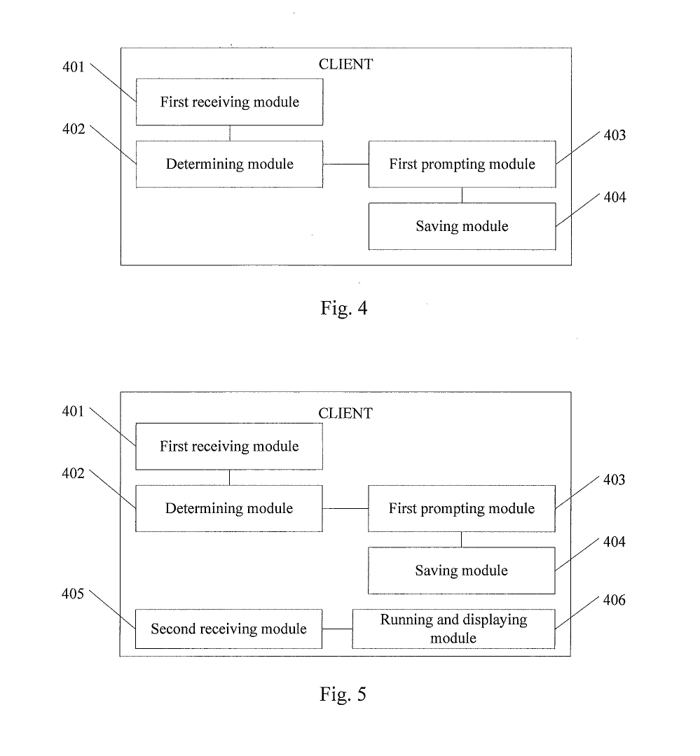

Referring to FIG. 4, the present disclosure provides a client, particularly the client includes: a first receiving module 401, a determining module 402, a first prompting module 403 and a saving module 404.

The first receiving module 401, is configured to receive a write operation sent by a user for a currently displayed web application.

The determining module 402, is configured to determine a current state of communication with a web server.

The first prompting module 403, is configured to prompt the user on whether to save written data corresponding to the write operation when communication with the web server cannot be performed currently.

The saving module 404, is configured to store the written data locally when the user chooses to save the written data, so that during communication with the web server next time, the written data is synchronized to the web server.

Furthermore, referring to FIG. 5, the client showed in FIG. 4 in the embodiment of the present disclosure further includes: a second receiving module 405 and a running and displaying module 406.

The second receiving module 405, is configured to receive a request for accessing to the web application sent by the user.

The running and displaying module 406, is configured to run offline resource files that are locally saved corresponding to the web application when communication with the web server cannot be performed currently, and display the web application.

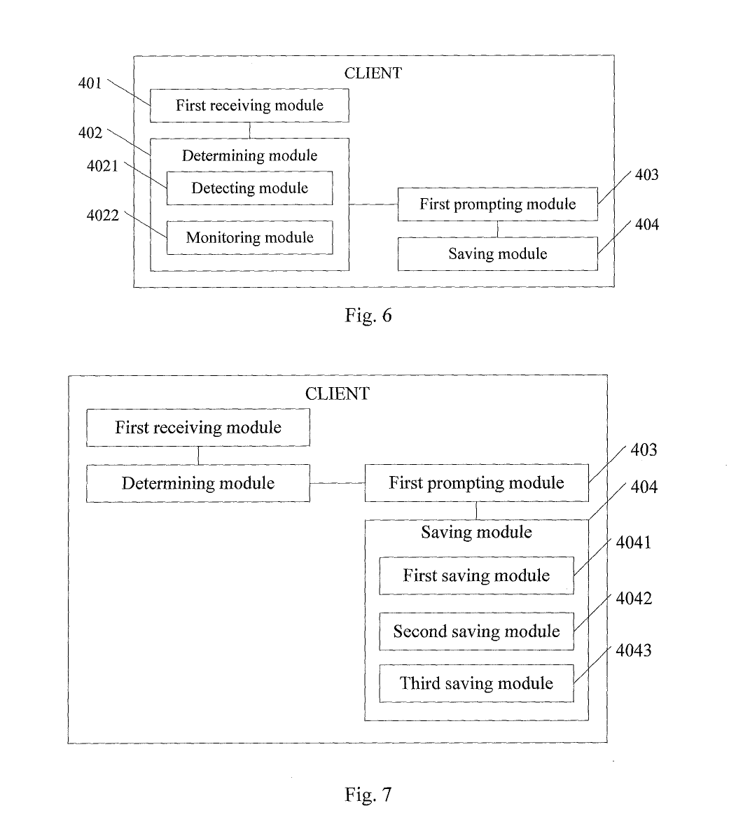

Furthermore, referring to FIG. 6, the determining module 402 showed in FIG. 4 may includes: a detecting module 4021 and a monitoring module 4022.

The detecting module 4021, is configured to detect a navigator.onLine interface; when the value of the navigator.onLine interface is detected to be true, then the browser may communicate with the web server currently, and when the value of the navigator.onLine interface is detected to be false, and then the browser may not communicate with the web server currently; or

the monitoring module 4022, is configured to monitor online events or offline events; when the online events are monitored, then the browser may communicate with the web server currently, and when the offline events are monitored, and then the browser may not communicate with the web server currently.

Furthermore, referring to FIG. 7, the saving module 404 showed in FIG. 4 may includes:

a first saving module 4041, is configured to save the written data using a LocalStorage mechanism; or

a second saving module 4042, is configured to save the written data using a WebDatabase mechanism; or

a third saving module 4043, is configured to save the written data using a SessionStorage mechanism.

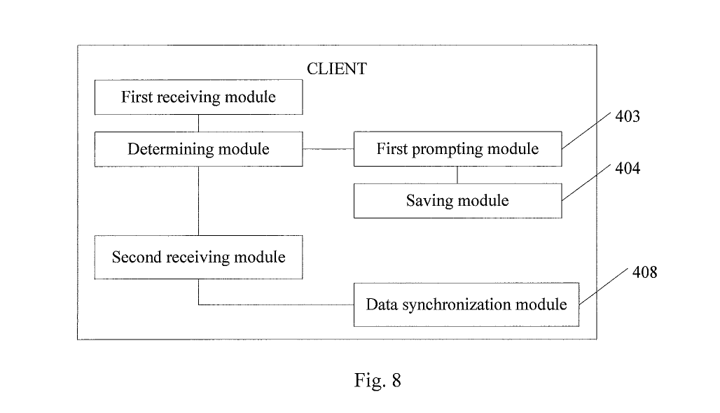

Furthermore, referring to FIG. 8, the client showed in FIG. 4 in the embodiment of the present disclosure further includes: a second prompting module 407 and a data synchronization module 408.

The second prompting module 407, is configured to prompt the user on whether to issue the written data that is locally saved during communication with the web server next time.

The data synchronization module 408, is configured to synchronize the written data to the web server when the user chooses to issue the written data that is locally saved.

In the embodiment of the present disclosure: when communication with the web server cannot be performed currently, the user may be prompted on whether to save the written data corresponding to the write operation, and when the user chooses to save the written data, then the written data can be saved locally, so that the written data is synchronized to the web server during communication with the web server next time. Thus, the dependency of the write operation for the web application on the network is decreased, and so the user can share information timely.

It should be noted that: the above embodiments describe the client for managing information, the above-mentioned function modules are defined and are taken here as examples for describing the present disclosure. In the practical application, the above-described functions and steps can be assigned and performed by different function modules as needed, namely, the internal structure of the client can be divided into different function modules to perform all or parts of the above described functions and steps. In addition, the client and the information management method provided by the above embodiments belong to the same conception, and the specific implementation processes of the client can refer to the method embodiments described above, which will not be repeated here again.

### A Fourth Embodiment

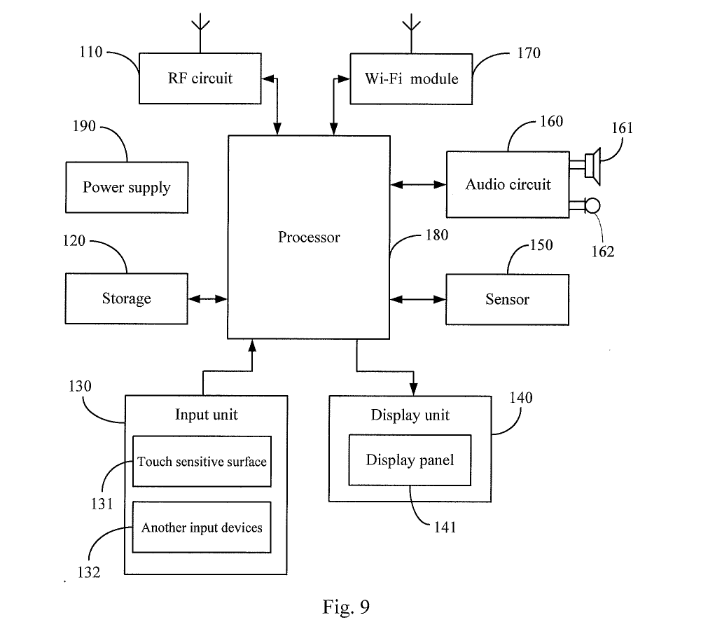

FIG. 9 is a structure diagram of a mobile terminal related to the embodiments of the present disclosure. The mobile terminal can be configured to perform the information management method provided in the above embodiments. Specially:

the mobile terminal 900 further includes: a radio frequency (RF) circuit 110, one or more than one storage 120 with computer readable storage medium, an input unit 130, a display unit 140, a sensor 150, an audio circuit 160, a Wi-Fi module 170, one or more than one processors 180, and a power supply 190. A person having ordinary skill in the art can understand that the structure of the terminal shown in the FIG. 9 cannot be a limitation to a terminal. That is, the mobile terminal may includes more or fewer elements than that as shown in the FIG. 9, or combinations of the elements shown in the FIG. 9, or other element arrangements which are different from the element arrangements shown in the FIG. 9.

The RF circuit 110 is used to receive and send information, or receive and send signals during a communication. Specially, the RF circuit 110 receives downlink information from a base station, and then sends the downlink information to one or more than one processor 180 to be processed. In addition, the RF circuit 110 also sends uplink data corresponding to the downlink information to the base station. Generally, the RF circuit 110 includes but not limited to: an antenna, at least one amplifier, a tuner, one or more than one oscillator, a subscriber identity module (SIM) card, a transceiver, a coupler, a low noise amplifier (LNA), and a duplexer. In addition, the RF circuit 100 may communicate with network and other devices in form of wireless communication. The wireless communication may use any communication standard or communication protocol, such as a global system of mobile communication (GSM), a general packet radio service (GPRS), a code division multiple access (CDMA), a wideband code division multiple access (WCDMA), long term evolution (LTE), an email, a short messaging service (SMS), etc.

The storage 120 may be used to store software programs and modules, such as the program instructions and modules corresponding to the browser of the above-mentioned embodiments, and store data which is generated during the process of browsing the web page under the weak light by the mobile terminal browser in the embodiment. The processor 180 can run the software programs and the modules stored in the storage 120 to execute the corresponding function applications and process the corresponding data, thus realizing the function of browsing the web page under the weak light with the mobile terminal browser. The storage 120 may mainly include a program storage area and a data storage area. The program storage area can store an operation system, at least one application program corresponding to one function (such as, a sound play function, an image play function, and so on). The data storage area can store data (such as audio data, phone book, and so on) created by the use of the terminal 1200. In addition, the storage 120 may include a high-speed random access memory and a nonvolatile memory, such as at least one disk storage device, flash memory device, or other volatile solid state memory device. Correspondingly, the storage 120 may further include a memory controller, to control the processor 180 and the input unit 130 to access the storage 120.

The input unit 130 may be used to receive input number or character information, and also used to be as a keyboard, a mouse, an operation rob, an optical input device or a trackball signal input device to conduct the user setup or function control. In detail, the input unit 130 may include a touch sensitive surface 131 and an input device 132. The touch sensitive surface 131 may be defined as a touch screen panel or a touchpad, which is used to receive an instruction generated by a touch operation on or around the touch sensitive surface 131, and drives a connection device corresponding to the instruction according to a predetermined program. The touch operation may be an operation of an object (such as a figure or a stylus) moving on or around the touch sensitive surface 131. Preferably, the touch sensitive surface 131 may include a touch detection device and a touch controller. The touch detection device detects a location of the user touching the touch sensitive surface 131, and detects a signal generated by touch operation, and transmits the signal to the touch controller. The touch controller receives the signal from the touch detection device, and converts the signal into a coordinate, and transmits the coordinate to the processor 180. The touch controller can receive an instruction from the processor 180 and execute the instruction. In addition, the touch sensitive surface 131 may be a resistive touch screen panel or touchpad, a capacitive touch screen panel or touchpad, an infrared touch screen panel or touchpad, a surface acoustic wave touch screen panel or touchpad, or other types touch screen panels or touch pads. The input unit 130 further includes other input devices 132. The other input devices 132 may include but not be limited to one or more of a physical keyboard, function keys (such as a volume key for controlling the volume of the terminal, a switch key, and so on), a trackball, a mouse, an operation rob, and so on.

The display unit 140 may be used to display information input by the user or supplied to the user, and display all kinds of graphical user interfaces (GUIs) of the mobile terminal 900. The GUIs may consist of graphs, texts, icons, videos, and any combination of the graphs, the texts, the icons, and the videos. The display unit 140 may include a display panel 141. The display panel 141 may be the liquid crystal display (LCD) panel or the organic light-emitting diode panel. Further, the touch sensitive surface 131 can cover the display panel 141. When the touch sensitive surface 131 detects the touch operation on or around the touch sensitive surface 131, the touch sensitive surface 131 transmits the instruction corresponding to the touch operation to the processor 180, to make the processor 180 determine a type of the touch operation. After the processor 180 determines the type of the touch operation, the processor 180 displays the determined type of the touch operation on the display panel 141. Although the touch sensitive surface 131 and the display panel 141 are two independent elements to respectively realize the input function and the output function in FIG. 8, in some embodiments, the touch sensitive surface 131 is integrated with the display panel 141 to realize the input function and the output function.

The mobile terminal 900 further may include at least one sensor 150, such as a light sensor, a motion sensor, and other sensors. In detail, the light sensor may include an ambient light sensor and a proximity sensor. The ambient light sensor can adjust the brightness of the display panel 141 according to the ambient light. The proximity sensor can turn off the display panel 141 and/or backlight when the mobile terminal 900 moves to the ear of the user. As one of the motion sensors, a gravity sensor can detect accelerations from every direction (generally the directions of three axles), and detect the gravity and a direction of the gravity. The gravity sensor also can determine special applications of a mobile phone (such as a switch from a landscape mode of the mobile phone to a portrait mode, games related to the pose of the mobile phone, a magnetometer pose calibration), and detects functions related to vibration (such as pedometer, knock). The mobile terminal 900 also has a gyroscope, a barometer, a hygrometer, a hygrometer, a thermometer, an infrared sensor, and so on.

Each of an audio circuit 160, a loudspeaker 161, and a microphone 162 has an audio interface to be supplied for the user. The audio circuit 160 may receive audio data and converts the audio data into an electrical signal, and transmit the electrical signal to the loudspeaker 160. The loudspeaker 160 converts the electrical signal into a sound signal, and outputs the sound signal. In addition, the loudspeaker 162 can receive a sound signal, converts the sound signal into an electrical signal, and outputs the electrical signal to the audio circuit 160. The audio circuit 160 receives the electrical signal, converts the electrical signal into an audio signal, and outputs the audio signal to the processor 180. The processor 180 processes the audio signal and outputs the processed audio signal to another terminal by RF circuit 110, or stores the processed audio signal in the storage 120. The audio circuit 160 may include a headphone jack, to connect to an external headphone to make the external headphone communicate with the mobile terminal 900.

The Wi-Fi belongs to a short-range wireless communication technology. The mobile terminal 900 can help the user to receive or send emails, and browse the web pages and access to the streaming media through an input/output interface of the Wi-Fi module 170. The mobile terminal 900 provides the wireless network to make the user can access the internet. Although there is the Wi-Fi module 170 in FIG. 9, it can be understood that the mobile terminal 900 may not include the Wi-Fi module 170. That is, the Wi-Fi module 170 of the mobile terminal 900 can be omitted according to need.

The processor 180 is a control center of the mobile terminal 900, and is connected to every portion of the mobile phone through all kinds of interfaces and cables. The processor 180 executes various functions and processes data of the mobile terminal 900 to monitor the mobile phone through running or executing the software programs and/or modules stored in the storage 120, or through invoking data stored in the storage 120. The processor 180 may include one processing core or more processing cores. Preferably, an application processor and a modem processor can be integrated into the processor 180. The application processor mainly processes the operation system, the user interface, application programs, and so on. The modem processor mainly processes the wireless communication. It can be understood that, the modem processor may not be integrated into the processor 180.

The mobile terminal 900 further includes a power supply 190 such as a battery for powering other elements of the mobile terminal 900. Preferably, the power supply 1900 is connected to the processor 180 through a power management system. The power management system is used to charge or discharge the power supply 190, and manages the power of the power supply 190, and so on. The power supply 190 may includes any combination of one or more than one direct current (DC) power or alternative current (AC) power, rechargeable battery system, fault detection circuit, converter, or inverter, power state indicator.

The mobile terminal 900 further may include a camera, a Bluetooth module, and so on, which are not shown here. In the embodiment, the display unit of the mobile terminal is a touch screen display, the mobile terminal still include a storage, and one or more than one program instructions stored in the storage for execution by one or more than one processors, the one or more than one program instructions comprising instructions: a first receiving instruction, which is configured to receive a write operation sent by a user for a currently displayed web application;

a determining instruction, which is configured to determine a current state of communication with a web server;

a first prompting instruction, which is configured to prompt the user on whether to save written data corresponding to the write operation when communication with the web server cannot be performed currently; and

a saving instruction, which is configured to store the written data locally when the user chooses to save the written data, so that during communication with the web server next time, the written data is synchronized to the web server.

Optionally, the one or more program instructions further comprising instructions:

a second receiving instruction, which is configured to receive a request for accessing to the web application sent by the user;

a running and displaying instruction, which is configured to run offline resource files that is locally stored corresponding to the web application when communication with the web server cannot be performed currently, and display the web application.

Optionally, the one or more than one program instructions further comprising instructions:

A detecting instruction, which is configured to detect a navigator.onLine interface, and when the value of the navigator.onLine interface is detected to be true, then the browser may communicate with the web server currently, and when the value of the navigator.onLine interface is detected to be false, and then the browser may not communicate with the web server currently; or

a monitoring instruction, which is configured to monitor online events or offline events, and when the online events are monitored, then the browser may communicate with the web server currently, and when the offline events are monitored, and then the browser may not communicate with the web server currently.

Optionally, the one or more than one program instructions further comprising instructions:

a first saving instruction, which is configured to save the written data using a LocalStorage mechanism; or

a second saving instruction, which is configured to save the written data using a WebDatabase mechanism; or

a third saving instruction, which is configured to save the written data using a SessionStorage mechanism.

Optionally, the one or more than one program instructions further comprising instructions:

a second prompting instruct, which is configured to prompt the user on whether to issue the written data that is locally saved during communication with the web server next time;

a Data synchronization instruction, which is configured to synchronize the written data to the web server when the user chooses to issue the written data that is locally saved.

In the embodiment of the present disclosure: when communication with the web server cannot be performed currently, the user can be prompted on whether to save the written data corresponding to the write operation, and when the user chooses to save the written data, the written data is saved locally, so that during communication with the web server next time, the written data is synchronized to the web server. Thus, the dependency of the write operation for the web application on the network is decreased, so that the user can share information timely.

The serial number of the embodiments of the present disclosure is only used for description, not represent for the good and bad points of the embodiments.

The foregoing descriptions are merely exemplary embodiments of the present invention, but not intended to limit the protection scope of the present invention. Any variation or replacement made by persons of ordinary skills in the art without departing from the spirit of the present invention shall fall within the protection scope of the present invention.

What is claimed is:

1. An information management method, comprising:
receiving a write operation sent by a user for a currently displayed web application;
determining a current state of communication with a web server;
when communication with the web server cannot be performed currently, prompting the user on whether to save written data corresponding to the write operation; and
when the user chooses to save the written data, saving the written data locally, so that during communication with the web server next time, the written data is synchronized to the web server.

2. The method according to claim 1, before step of receiving a write operation sent by a user for a currently displayed web application, the method further comprising:
receiving a request for accessing to the web application sent by the user; and
when communication with the web server cannot be performed currently, running offline resource files that is locally saved corresponding to the web application, and displaying the web application.

3. The method according to claim 1, the step of determining a current state of communication with a web server, comprising:
detecting a navigator.onLine interface, when the value of the navigator.onLine interface is detected to be true, then the browser may communicate with the web server currently, and when the value of the navigator.onLine interface is detected to be false, and then the browser may not communicate with the web server currently; or
monitoring online events or offline events, when the online events are monitored, then the browser may communicate with the web server currently, and when the offline events are monitored, and then the browser may not communicate with the web server currently.

4. The method according to claim 1, the step of storing the written data locally, comprising: saving the written data using a LocalStorage mechanism, or saving the written data using a WebDatabase mechanism, or saving the written data using a SessionStorage mechanism.

5. The method according to claim 1, wherein during communication with the web server next time, the written data is synchronized to the web server, which comprises:
during communication with the web server next time, prompting the user on whether to issue the written data that is locally saved; and
when the user chooses to issue the written data that is locally saved, synchronizing the written data to the web server.

6. A client, the client comprising: a first receiving module, a determining module, a first prompting module and a saving module;
the first receiving module, configured to receive a write operation sent by a user for a currently displayed web application;
the determining module, configured to determine a current state of communication with a web server;
the first prompting module, configured to prompt the user on whether to save written data corresponding to the write operation when communication with the web server cannot be performed currently; and
the saving module, configured to store the written data locally when the user chooses to save the written data, so that during communication with the web server next time, the written data is synchronized to the web server.

7. The client according to claim 6, the client further comprising:
a second receiving module, configured to receive a request for accessing to the web application sent by the user; and
a running and displaying module, configured to run offline resource files that are locally saved corresponding to the web application when communication with the web server cannot be performed currently, and display the web application.

8. The client according to claim 6, the determining module comprising:
a detecting module, configured to detect a navigator.onLine interface, when the value of the navigator.onLine interface is detected to be true, then the browser may communicate with the web server currently, and when the value of the navigator.onLine interface is detected to be false, and then the browser may not communicate with the web server currently; or
a monitoring module, configured to monitor online events or offline events, when the online events are monitored, then the browser may communicate with the web server currently, and when the offline events are monitored, and then the browser may not communicate with the web server currently.

9. The client according to claim 6, the saving module comprising:
a first saving module, configured to save the written data using a LocalStorage mechanism; or
a second saving module, configured to save the written data using a WebDatabase mechanism; or
a third saving module, configured to save the written data using a SessionStorage mechanism.

10. The client according to claim 6, the client further comprising:
a second prompting module, configured to prompt the user on whether to issue the written data that is locally saved during communication with the web server next time; and
a data synchronization module, configured to synchronize the written data to the web server when the user chooses to issue the written data that is locally saved.

11. A mobile terminal, the mobile terminal include a storage, one or more than one processors and one or more than one program instructions stored in the storage for execution by the one or more than one processors, the one or more than one program instructions comprising instructions:
a first receiving instruction, which is configured to receive a write operation sent by a user for a currently displayed web application;
a determining instruction, which is configured to determine a current state of communication with a web server;
a first prompting instruction, which is configured to prompt the user on whether to save written data corresponding to the write operation when communication with the web server cannot be performed currently; and
a saving instruction, which is configured to save the written data locally when the user chooses to save the written data, so that during communication with the web server next time, the written data is synchronized to the web server.

12. The mobile terminal according to claim 11, the one or more than one program instructions further comprising instructions:
a second receiving instruction, which is configured to receive a request for accessing to the web application sent by the user; and
a running and displaying instruction, which is configured to run offline resource files that is locally saved corresponding to the web application when communication with the web server cannot be performed currently, and display the web application.

13. The mobile terminal according to claim 11, the one or more than one program instructions further comprising instructions:
a detecting instruction, which is configured to detect a navigator.onLine interface, and when the value of the navigator.onLine interface is detected to be true, then the browser may communicate with the web server currently, and when the value of the navigator.onLine interface is detected to be false, and then the browser may not communicate with the web server currently; or
a monitoring instruction, which is configured to monitor online events or offline events, and when the online events are monitored, then the browser may communicate with the web server currently, and when the offline events are monitored, and then the browser may not communicate with the web server currently.

14. The mobile terminal according to claim 11, the one or more than one program instructions further comprising instructions:
a first saving instruction, which is configured to save the written data using a LocalStorage mechanism; or
a second saving instruction, which is configured to save the written data using a WebDatabase mechanism; or
a third saving instruction, which is configured to save the written data using a SessionStorage mechanism.

15. The mobile terminal according to claim 11, the one or more than one program instructions further comprising instructions:
a second prompting instruction, which is configured to prompt the user on whether to issue the written data that is locally saved during communication with the web server next time; and
a data synchronization instruction, which is configured to synchronize the written data to the web server when the user chooses to issue the written data that is locally saved.
